(19) United States
(12) Patent Application Publication
(10) Pub. No.: US 2011/0213618 A1
(43) Pub. Date: Sep. 1, 2011

(54) System and Method for Automating Correctional Facilities

(76) Inventors: RON HODGE, FRESNO, CA (US); GREGG HODGE, FRISCO, CO (US)

(21) Appl. No.: 12/868,974

(22) Filed: Aug. 26, 2010

Related U.S. Application Data
(60) Provisional application No. 61/237,248, filed on Aug. 26, 2009.

(51) Int. Cl. G06Q 50/00

(52) U.S. Cl. 705/1.1

(57) ABSTRACT

An automated kiosk, located within a correctional facility, is configured for automating functions related to the handling of money between inmates and facility personnel. Kiosks accept money from inmates upon booking and dispense money cards to inmates upon their release. Kiosks further permits persons to post bail for an inmate, provide money to an inmate's commissary account, and paying for an inmate's work release fees. Kiosks also communicate with the facility internal databases and computing systems to update records associated with posting of bail and crediting of money to an inmate's account. Kiosks also capture inmate's fingerprints or three-dimensional facial renderings to assist with identification. Persons may also access a website associated with the correctional facility wherein the person may post bail for an inmate, provide money to an inmate's commissary account, and paying for an inmate's work release fees.

### RELATED APPLICATIONS

The present application claims benefit of priority pursuant to 35 U.S.C. §119(e) of U.S. Provisional Pat. App. No. 61/237,248, filed Aug. 26, 2009, entitled “SYSTEM AND METHOD FOR PROVIDING AUTOMATED SERVICES TO CORRECTIONAL FACILITIES,” which is hereby incorporate by reference in its entirety.

### BACKGROUND

When a correctional facility books an inmate, the inmate's belonging are accounted for by facility personnel. Such belongings include amongst other things the cash in possession of the inmate. In order to prevent possibly fraudulent activities, the cash is often counted by multiple personnel causing an increase in resources and time required to book an inmate. Further, the handling of such money gives way to possible theft due to the number of additional persons that handle the money along the way. Upon release of an inmate, any money due to the inmate is provided to them in either cash or a check. Allowing the inmate to leave with cash can be dangerous. On the other hand, issuing a check to the inmate requires them to find a financial institution where the check can be cashed. Additionally, it is common for the released inmate to attempt to falsify the amount on the check, causing fraudulent activities.

Additionally, once an inmate is incarcerated, outside persons may wish to provide money to the inmate for use in the commissary or to pay for work release fees. Traditionally, such persons would have to come to the facility and give the inmate cash directly, or through the assistance of facility personnel. This can increase administrative work and/or the possibility of theft.

Further, when an inmate or someone associated with them wishes to post bail, additional administrative steps are required to receive the money, apply it to the inmate's account, notify the facility of the bail posting, etc. The person posting bail is also required to come to the facility and provide cash.

Lastly, another area normally requiring the use of cash is to pay for an inmate's work release fees, if they have the option of work release while being incarcerated. Again, this leads to administrative resources to process the transaction and account for the cash.

A system and method is needed to address the shortcomings of the above system of handling money within a correctional facility.

### SUMMARY

In one embodiment of the present invention, a correctional facility system is described. The correctional facility system comprises a booking kiosk configured to automate steps for booking an inmate into the correctional facility, wherein the booking kiosk is further configured to communicate with one or more databases associated with the correctional facility to provide information about the inmate's booking. The correctional facility system may further comprise a lobby kiosk configured to automate steps for providing a source of money to the inmate, wherein the lobby kiosk is further configured to communicate with the one or more databases associated with the correctional facility to provide information about a source of money received and associated with the inmate.

The present invention also discloses a method for booking an inmate into a correctional facility, comprising entering the inmate's identification information into a kiosk, inserting money in possession of the inmate into kiosk, and receiving a verification of the received money.

The present invention also discloses a method of receiving a request to book an inmate into a correctional facility, comprising receiving identification information of an inmate at a kiosk, receiving money in possession of the inmate via the kiosk, associating the received money with the inmate's account, and providing verification of the received money.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings where like or similar elements are designated with identical reference numerals throughout the several views and wherein:

FIG. 1 illustrates example system architecture for utilizing one or more automated kiosks within a correctional facility;

FIG. 2 illustrates an automated kiosk and the functional components therein;

FIG. 3 illustrates example operations for booking an inmate;

FIG. 4 illustrates example operations for processing the booking of an inmate;

FIG. 5A illustrates example operations for providing money to an inmate's account;

FIG. 5B illustrates example operations for providing money to an inmate's account;

FIG. 6 illustrates example operations for processing a request to provide money to an inmate's account; and

FIG. 7 illustrates a perspective view of an automated kiosk.

### DETAILED DESCRIPTION

The present application discloses a system and method for permitting correctional facilities such as jails, prisons, and detention centers to automate many of the tasks normally handled by facility personnel. For example, the invention permits such facilities to become cashless in their handling of an inmate's money from the time an inmate is booked into a facility until the time the inmate is later released. The present application provides for a system of using one or more automated kiosks within a correctional facility to alleviate the burden of collection and distribution of cash when an inmate is booked and later released. An automated kiosk is standalone machine having similar functionality to an automated teller machine (ATM). The kiosk may have a touch screen and/or keyboard for inputting information, a coin/bill acceptor, a credit/debit card reader, a display, and a printing device to provide a receipt of a transaction. In order to communicate with a correctional facility, the kiosk may also include a network adapter to connect, either wired and/or wirelessly, to the facility's computing system(s). Further, the kiosk may also communicate with the Internet. Inside the kiosk may be a computing system such as a personal computer (“PC”) or computer server. The PC or server may have one or more installed software applications responsible for providing the front-end and back-end application(s) used to interface with a user of the kiosk and the facility's computing system(s).

In one embodiment, one or more booking kiosks may be located in the booking or processing area of the correctional facility. When an inmate is brought into the facility for booking, facility personnel, such as the booking officer, may process the inmate by entering information into the booking kiosk. Such information may include the name of the booking officer, the inmate's full name, date of birth, identification characteristics, date and time of the booking and any other information a correctional facility may wish to include when an inmate is booked.

In addition to inputting booking information into the kiosk, the booking officer traditionally retrieves personal belonging of the inmate, including cash. All retrieved cash is inserted into the booking kiosk and associated with the inmate's account. The kiosk will provide hard copy receipts showing the amount of money received and posted to the inmate's account. One copy of the receipt may be provided to the facility, with the other copy being placed into the inmate's personal belongings bag. Further, the kiosk may interface with the facility's software systems and databases to provide details of the received money and its association with the inmate's account.

In another embodiment, the booking kiosk may also provide for Internet-based communications (e.g., email, SMS or MMS text messages) to be sent to one or more persons on behalf of the inmate. Such communications may be used to alert such persons that the inmate has been booked into the facility. Persons receiving such messages may include the inmate's family, friends, and attorney. The inmate or facility personnel may input a phone number or email address into the kiosk, wherein the kiosk may relay the message, via the Internet, to the recipient(s).

Along with one or more kiosks being placed in a facility's booking area, additional kiosks may be placed in the facility's lobby. Such kiosks may be used by persons wishing to either 1) post bail for an inmate; 2) load money into the inmate's account; or 3) pay an inmate's work release fees. Lobby kiosks may be placed in an area accessible by the public such as a lobby or waiting room.

Upon posting bail from a correctional facility, an inmate may receive any remaining balance of his account in the form of a debit or money card. In one embodiment, the debit card may be usable at an ATM to receive money up to the amount available on the debit card. In another embodiment, the debit card may also be usable as a VISA™ or MASTERCARD™ debit card. Hence, the card may be used anywhere that VISA™ or MASTERCARD™ is accepted. In one embodiment, a kiosk located within the facility may be capable of dispensing the debit card to the released inmate. In another embodiment, the debit card is provided to the inmate by facility personnel.

An additional feature of a kiosk within a facility may be to receive payment of an inmate's work release fees. In other words, if an inmate is permitted work release while incarcerated, fees may be required for use of such privileges. A kiosk may be used to receive payment for the work release fees. The kiosk may be accessible to the inmate or to other persons wishing to make payment for such fees. Further, the kiosk may interact with software applications and/or databases used to maintain work release information. Hence, the work release software and/or database would be updated with the payment information. In another embodiment, a kiosk may also permit an inmate to transfer funds from their account in order to make payment of their work release fees.

In addition to using a standalone kiosk located within a correctional facility, an Internet website may also be used to receive payments for loading money to an inmate's account, posting bail for an inmate, and making payments for an inmate's work release fees. For example, a user may navigate to a payment website using a computer and an Internet browser. The website may further communicate with the appropriate correctional facility's software applications and/or databases to update records showing that a payment has been received. For example, if the payment was to post bail, the facility is notified that the inmate posted bail and to begin processing the inmate for release. If the payment were used to load money to an inmate's account, the facility's accounting system and database would be updated with the new balance. Lastly, if the payment were for an inmate's would release fees, the appropriate system would be updated with the necessary information to show that such fees have been paid.

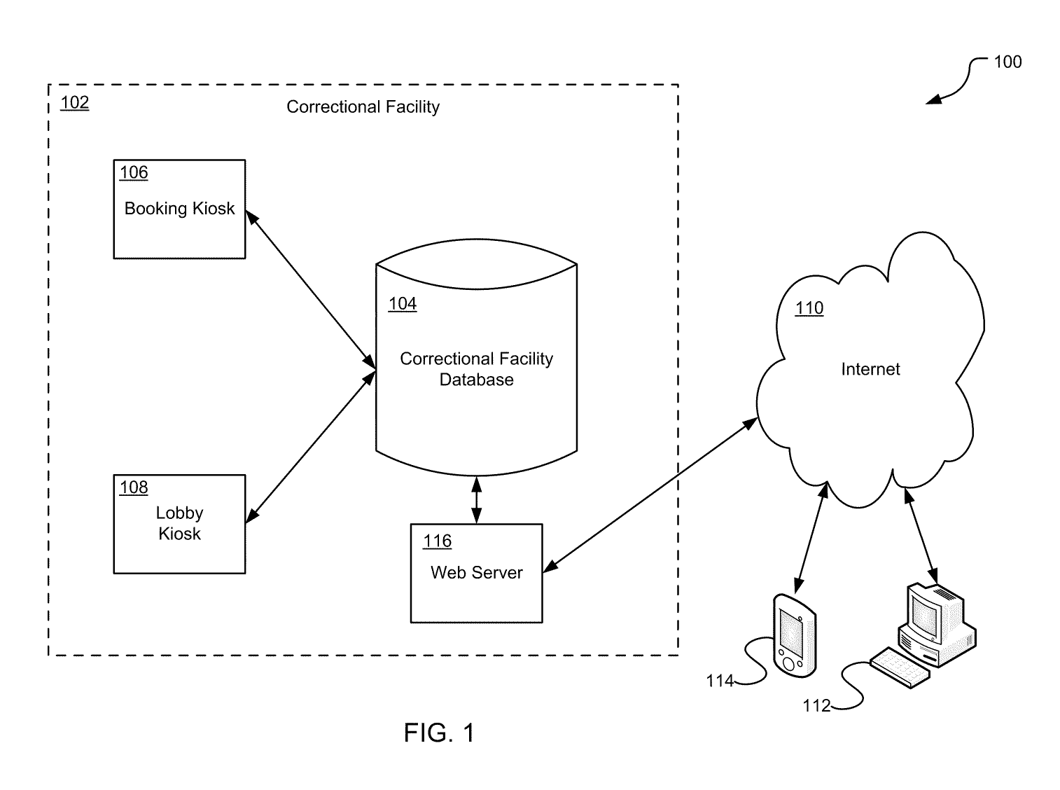

FIG. 1 illustrates example system architecture for utilizing one or more automated kiosks within a correctional facility. System 100 includes a correctional facility 102 having a database 104. The database 104 may store, amongst other things, records of the inmates held at the correctional facility 102, the amount of money associated with each inmate, and each inmate's bail amount. The database 104 may also include records of each financial transaction associated with each inmate. For example, an inmate may have a record of the cash they possessed when booked, a transaction posting $50 to the inmate's account through a lobby kiosk or the Internet, and a $10 transaction of the inmate purchasing something from the commissary.

The correctional facility 102 further includes a booking kiosk 106. The booking kiosk 106 may be located in a booking or processing area of the correctional facility 102. The booking kiosk 106 is further configured to communicate with the database 104 and any additional systems (not shown) within the correctional facility 102. In one embodiment, the correctional facility 102 may include two or more booking kiosks 106.

The correctional facility 102 may also include a lobby kiosk 108. The lobby kiosk 108 may be placed in a publicly assessable location within the correctional facility such as a lobby. The lobby kiosk 108 is further configured to communicate with the database 104 and any additional systems (not shown) within the correctional facility 102. In one embodiment, the correctional facility 102 may include two or more lobby kiosks 108. In another embodiment, each of the kiosks located within the correctional facility 102 may be capable of communicating with each other.

A remote computer 112 may also communicate with the database 104, through a web server 116, via the Internet 110. Such remote access may be through the form of a web-based application or website hosted on the web server 116, or a client-based application installed on the computer. The web server may be located within or external to the correctional facility 102. Additionally, any portable device 114 capable of connecting to the Internet 110 may communicate with the database 104, such as a smart phone, tablet PC, and eReader to name a few. As stated above, the remote computer 112 and the portable device 114 may interact with the database 104 in a similar manner as using the lobby kiosk 108. In other words, the remote computer 112 and portable device 114 may: 1) credit an inmate's account with money; 2) post bail for an inmate; and 3) pay for an inmate's work release fees. In one embodiment, the remote computer 112 or portable device 114 may communicate (i.e., wired or wirelessly) with the database 104 through a LAN or WAN (not shown).

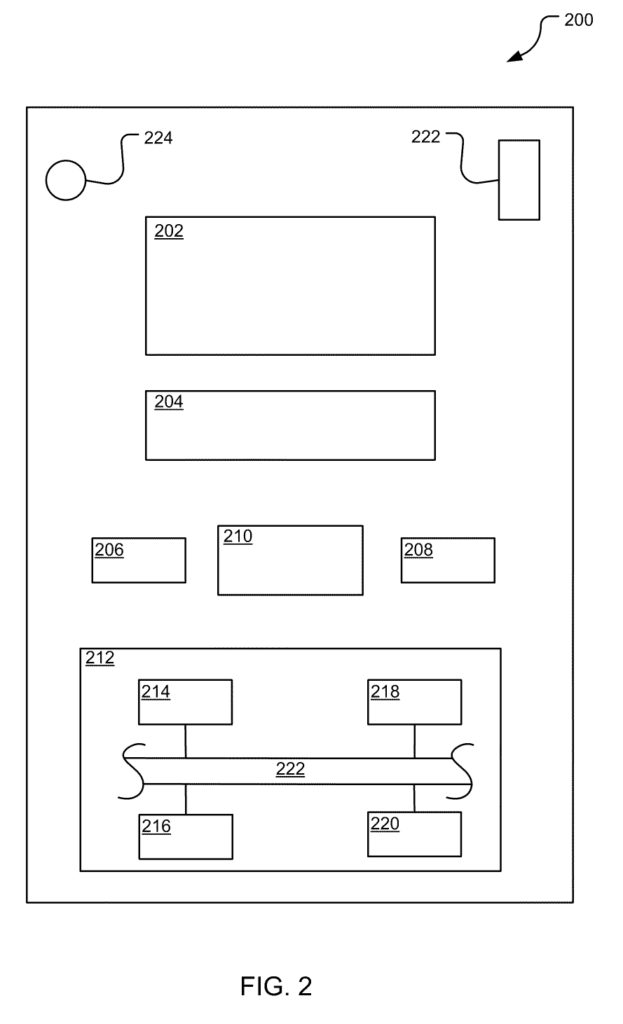

FIG. 2 illustrates an automated kiosk and the functional components therein. A kiosk 200 comprises multiple components in order to provide the functionality described within the application. One skilled in the art can appreciate that additional components may be added to the kiosk, as well as one or more components being removed. The kiosk 200 includes a display 202 such as a CRT or LCD, thus providing visual feedback to a user of the kiosk 200. Additionally, the kiosk 200 may include an input device 204 such as a keyboard and/or mouse/trackball. The input device enables a user to interact with the kiosk 200. In one embodiment, the display 202 may be a touch-screen, thus enabling the user to interact with the kiosk from the touch screen. In such an embodiment, the separate input device 204 may or may not be included depending on the preferences of the correctional facility.

In order for the kiosk 200 to accept funding, the kiosk 200 includes a coin/bill collector 206 and/or a credit/debit card reader 208. The coin/bill collector 206 may accept both coins and paper bills. The card reader 208 may read the magnetic strip of both credit cards and debit cards. The kiosk may also include a printing device 210 for printing a hardcopy receipt of a completed transaction. In one embodiment, a receipt may include the inmate's name, ID, transaction type, amount of transaction and type of funding source (e.g., cash or credit/debit card).

In addition, the kiosk also comprises a computer system 212 such as a personal computer or computer server, to name a few. The computer system 212 includes a CPU 214, a memory 216, a graphics processor 218, and a network interface 220. Each of these components may communicate with each other through communication bus 222. The computing system 212 also includes or more software applications (not shown) for interacting with a user. In one embodiment, the kiosk 200 may also comprise a debit/money card dispenser (not shown). Such a debit card may be used by an inmate upon posting bail. If the inmate's account has a positive balance, the inmate may approach the kiosk 200 to receive a debit card up to the amount of the inmate's positive balance. Such a debit card may be useable at any location accepting debit/credit cards such as banks, ATMs, grocery stores, convenience stores, etc.

In another embodiment, the kiosk 200 may include one or more components for identifying an inmate. For example, a booking kiosk may include a fingerprint reader 222 such that an inmate, upon booking, may be fingerprinted. The booking kiosk may capture the inmate's fingerprint and transmit the information to the database 104 and/or additional local, state, or federal law enforcement databases. When the inmate posts bail, the inmate may have their fingerprint taken again to verify their identity. Such an implementation may alleviate the possibility of the wrong inmate being released. In other words, if the fingerprint taken at booking does not match the fingerprint taken at release, it may be presumed that the wrong inmate has been prepared for release.

In another embodiment, the kiosk may also include a facial recognition device 224 such that an inmate's facial features are captured at the time of booking. Such a device may capture the contours of the inmate's face such that a three-dimensional model of the inmate's face is rendered. In another embodiment, the facial recognition device may also take a photograph of the inmate's face. The facial recognition device may be used to capture another image or 3D rendering at the time of an inmate's release. The booking image or rendering may be compared against a release image or rendering to verify that the correct inmate is being released.

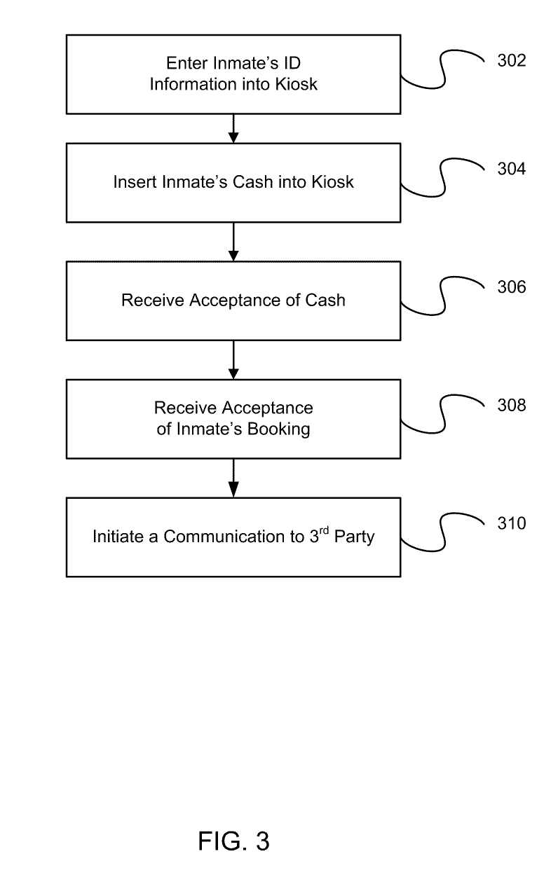

FIG. 3 illustrates example operations 300 for booking an inmate. It is noted that the term “inmate” may refer to a person already incarcerated, a person about to become incarcerated and presently in the booking process, or a person who has posted bail, yet still remains within a correctional facility. When an inmate set for incarceration is brought to the correctional facility, the booking officer brings the inmate to the booking area where one or more booking kiosks are located. In operation 302, the booking officer enters the inmate's identification information into the kiosk. Such information may include, name, height, weight, age, DOB, race, gender, etc. In an alternative operation, if the kiosk is equipped with a fingerprint reader and/or a facial recognition device, the booking officer may operate such devices to capture a fingerprint, 3D facial rendering, or photograph of the inmate. Next, in operation 304 the officer or inmate inserts any money into the kiosk that may be in possession of the inmate. A coin and bill reader is used to receive the cash. In operation 306, the officer receives a verification of the money received by the kiosk. The verification may come in the form of one or more printed receipts stating the amount of money received and the name and identification of the inmate. In operation 308, the officer may receive a printed confirmation of the inmate's booking. Such a confirmation may include a booking identification number and other identifying information.

In optional operation 310, the officer may initiate a communication to a 3^{rd} party alerting them of the inmate's booking. For example, the kiosk may be configured to send a text message (e.g., IM, MMS, SMS) or an email to the inmate's family, friends, or attorney. In such an embodiment, an email address or phone number may be input into the kiosk. The contents of the message may be of a standard format or customizable by the officer or inmate.

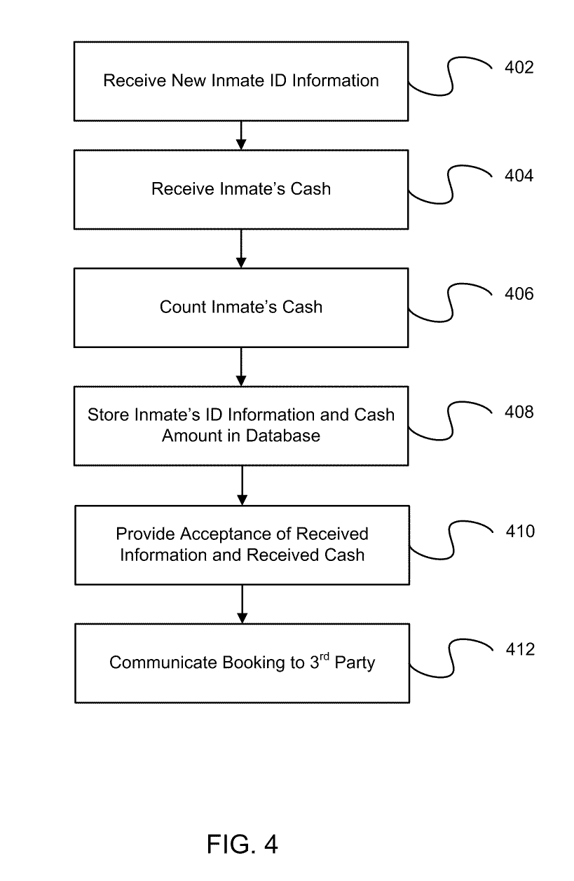

FIG. 4 illustrates example operations 400 for processing the booking of an inmate. Upon arrival of an inmate to a booking area of a correctional facility, a booking officer enters identification information of the inmate into a booking kiosk. In operation 402, the inmate's identification information is received. Such information may include, name, height, weight, age, DOB, race, gender, etc. In optional operation 404, any money in possession of the inmate may be received via a coin/bill reader. Upon receipt of money, in operation 406 the inmate's money is counted through functionality implemented in the coin/bill reader.

In an optional operation, if the kiosk is equipped with a fingerprint reader and/or a facial recognition device, digital information representative of a fingerprint, 3D facial rendering, or photograph of the inmate is received.

In operation 408 the inmate's identification information and a deposited money amount is communicated to one or more databases associated with the correctional facility. Such a database may include an inmate accounting system that maintains records of financial transactions for each inmate. Additional databases may include a general inmate database that maintains records of each inmate in the facility, each inmate's identification information, bail amounts, booking date, incarceration release date, etc. Optionally, if the kiosk is equipped with a fingerprint reader and/or facial recognition devices, the information associated with such renderings may be stored in the general inmate database or other optional databases associated with the correctional facility, or local, state, and, federal law enforcement agencies.

In operation 410, a confirmation of the inmate's booking, identification information and inserted money is dispensed from the kiosk in the form of a printed receipt. In optional operation 412, a request to communicate the booking to a 3^{rd} party may be received. Such a request results in a communication being sent to a 3^{rd} party alerting them of the inmate's booking. For example, the communication may be in the form of a text message (e.g., IM, MMS, SMS) or an email to the inmate's family, friends, or attorney. In such an embodiment, an email address or phone number may be input into the kiosk. The message may be of a standard format or customizable by the officer or inmate.

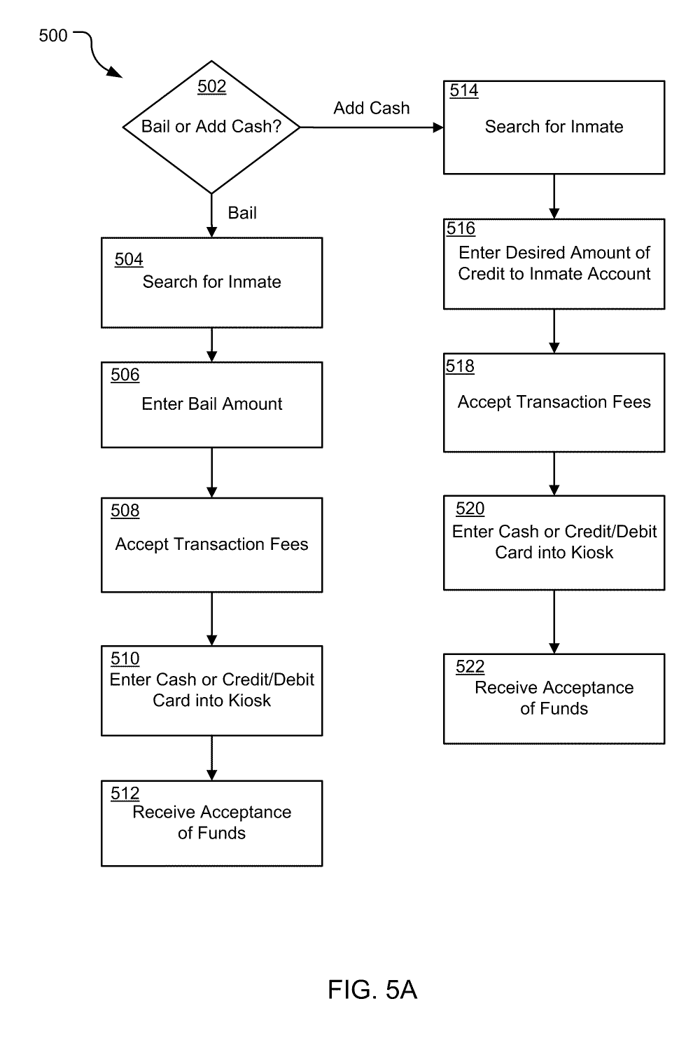

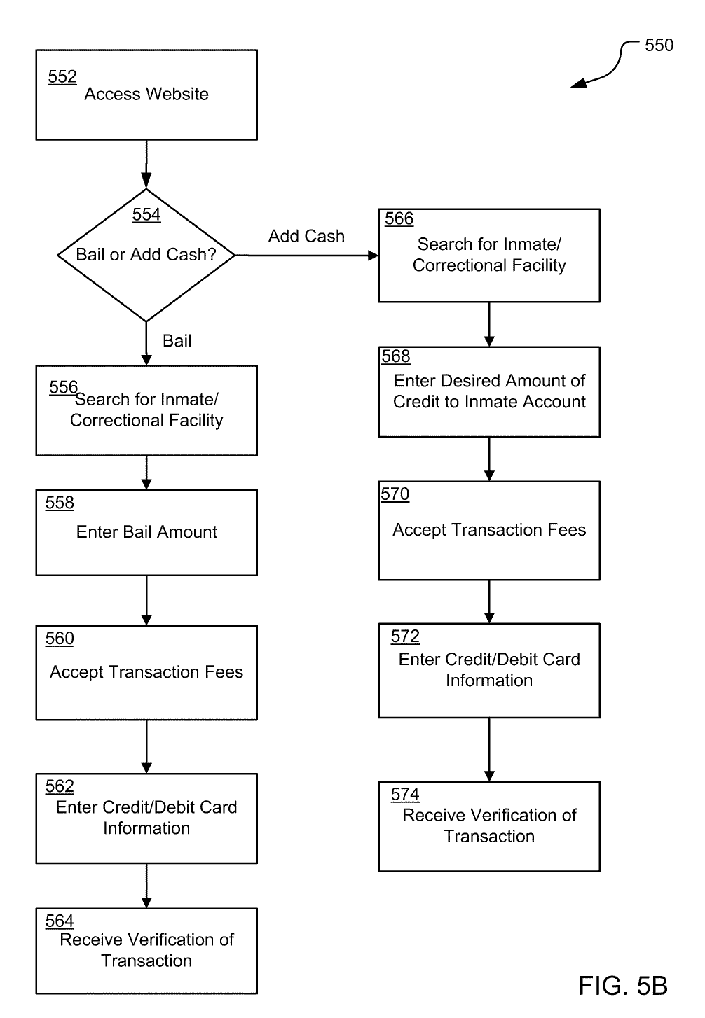

FIG. 5A illustrates example operations 500 for providing money to an inmate's account. The following operations may be carried out by a user of a kiosk located within a publicly accessible area of a correctional facility such as a lobby. In operation 502, upon approaching a kiosk, a user is presented with an option to add money to an inmate's account or to post bail for an inmate. If the user selects to post bail, the user then searches for the inmate in operation 504. The user may search by first or last name or by the first letter of the inmate's first or last name. The search result may include a list of all inmates meeting the search criteria. Such a list may include last name, first name, race, DOB, and booking number. Upon selecting the desired inmate, the person enters the bail amount in operation 506. In one embodiment, the user is expected to know the proper amount needed to post bail. In another embodiment, a display on the kiosk may state the bail amount. In one embodiment, the kiosk may charge one or transaction and/or processing fees for using the kiosk. The amount of such fees would be presented to the user on the kiosk's display. In optional operation 508, the user accepts the transaction and/or processing fees. In operation 510, the user inserts the total amount for posting bail and any optional processing fees. In one embodiment, the user may insert cash into a coin/bill reader of the kiosk. Alternatively, the user may insert a credit/debit card into a card reader of the kiosk. Upon receipt of the correct amount, the user receives a confirmation of the received money in operation 512. Such a confirmation may come in the form of a printed receipt, through email, or any other means of communication know by those skilled in the art.

Returning to operation 502, if the user wishes to add money to an inmate's account, the user searches for the inmate in operation 514. The user may search by first or last name or by the first letter of the inmate's last name. The search result may include a list of all inmates meeting the search criteria. Such a list may include last name, first name, race, DOB, and booking number. Upon selecting the desired inmate, the person may enter a desired amount of money to credit the inmate's account in operation 516. In one embodiment, the kiosk may charge one or transaction and/or processing fees for using the kiosk. The amount of such fees would be presented to the user on the kiosk's display. In optional operation 518, the user accepts the transaction and/or processing fees. In operation 520, the user inserts the total amount for posting bail and any optional processing fees. In one embodiment, the user may insert cash into the coin/bill reader of the kiosk. Alternatively, the user may insert a credit/debit into the card reader of the kiosk. Upon receipt of the correct amount, the user receives a confirmation of the received money in operation 522. Such a confirmation may come in the form of a printed receipt, through email, or any other means of communication know by those skilled in the art.

FIG. 5B illustrates example operations 550 for providing money to an inmate's account through a remote computer or portable device. A user may perform similar functions as discussed in FIG. 5A but though a web-based application, website, or client-based application. In operation 502, a user accesses a website via a remote computer or portable device capable of accessing the Internet. Upon accessing the website, in operation 554 the user is presented with an option to add money to an inmate's account or to post bail for an inmate. If the user selects to post bail, the user then searches for the inmate and the associated correctional facility in operation 556. The user may select the desired correctional facility by using a drop-down box or the like. The user may search by first or last name or by the first letter of the inmate's last name. The search result may include a list of all inmates meeting the search criteria. Such a list may include last name, first name, race, DOB, and booking number. Upon selecting the desired inmate, the person enters the bail amount in operation 558. In one embodiment, the user is expected to know the proper amount needed to post bail. In another embodiment, the website may state the bail amount.

In one embodiment, the website may charge one or transaction and/or processing fees for using the service. The amount of such fees would be presented to the user on the website. In optional operation 560, the user accepts the transaction and/or processing fees. In operation 562, the user provides credit/debit card information such as name, billing address, card number, etc. Once the transaction is processed, the user receives a confirmation of the transaction and verification that the inmate has posted bail in operation 564. Such a confirmation may come in the form of a printable screenshot, through email, a downloadable file, or any other means of communication know by those skilled in the art. Alternatively, if the credit/debit card is declined, an appropriate notification is presented to the user.

Returning to operation 554, if the user wishes to add money to an inmate's account, the user searches for the desired inmate and the appropriate correctional facility in operation 566. The user may select the desired correctional facility by using a drop-down box or the like. The user may search by first or last name or by the first letter of the inmate's last name. The search result may include a list of all inmates meeting the search criteria. Such a list may include last name, first name, race, DOB, and booking number. Upon selecting the desired inmate, the person may enter a desired amount of money to credit the inmate's account in operation 568. In one embodiment, the website may charge one or transaction and/or processing fees for using the service. The amount of such fees would be presented to the user via the website. In optional operation 570, the user accepts the transaction and/or processing fees. In operation 572, the user provides credit/debit card information such as name, billing address, card number, etc. Once the transaction is processed, the user receives a confirmation of the transaction and verification that the inmate's account has been debited by the appropriate amount, in operation 574. Such a confirmation may come in the form of a printable screenshot, through email, a downloadable file, or any other means of communication know by those skilled in the art. Alternatively, if the credit/debit card is declined, an appropriate notification is presented to the user.

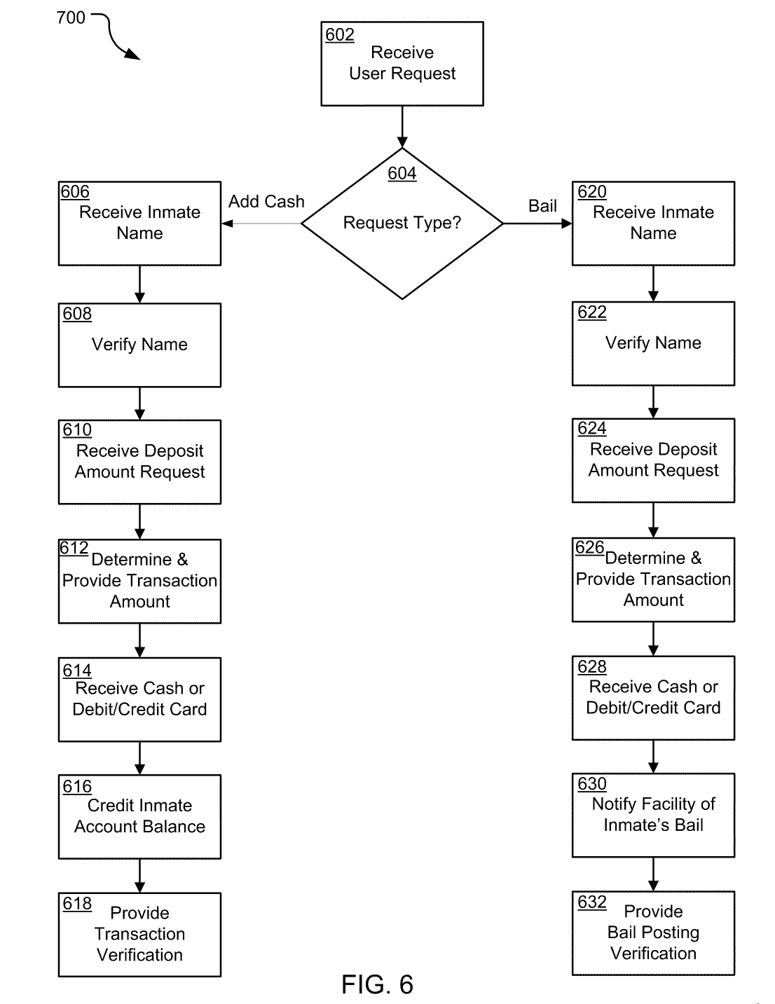

FIG. 6 illustrates example operations 600 for processing a request to provide money to an inmate's account. In one embodiment, some of the subsequent operations may be received from a user via a kiosk communicatively coupled to the correctional facility's computing system via the Internet, a LAN, or a WAN. In another embodiment, some of the subsequent operations may be received from a user via a website communicatively coupled to the correctional facility's computing system via a web server over the Internet, a LAN, or a WAN. In operation 602, a user request for crediting an inmate's account is received. In operation 604, a selection is presented to the user to either post bail for an inmate or provide an amount of money to the inmate's account. In an optional embodiment, the user could be presented with a third option of paying for an inmate's work release fees. If the user elects to provide money to the inmate's account, such a selection is received in operation 606. In operation 608, the name of the inmate is verified through one more search criteria received from the user. In one embodiment, if the user is accessing the service from a website over the Internet, a selected correctional facility is also provided. Alternatively, if the user is accessing the service from a kiosk, the correctional facility is evident due to the location of the kiosk within a facility. Once the correct inmate is verified, a request for an amount of money to be credit to the inmate's account is received in operation 610.

In optional operation 612, a transaction and/or processing fee(s) may be added to the transaction amount. Such fees may be based on a fixed amount and/or based on a percentage of the transaction amount. The additional fees are then presented to the user. If the user agrees to and accepts the fees, a funding source is received in operation 614. If the user is accessing the service through a kiosk, the funding source may come in the form of cash inserted into a coin/bill reader or in the form of a credit/debit card swiped through a card reader. Alternatively, if the user is accessing the service through a website, the funding source is received in the form of credit/debit card information and a billing address. Once, the funding source has been received and verified, the inmate's account balance is credited with the amount of the transaction, minus any received fees, in operation 616. If the user is accessing the service from a kiosk, the kiosk communicates to a database of the correctional facility to update the records of the inmate. If the user is accessing the service from a website, a web server associated with the correctional facility communicates to a database of the correctional facility to update the records of the inmate. Lastly, in operation 618 a verification of the completed transaction is provided to the user. Such verification could be in the form of a printed receipt from a kiosk, through email, text message or any other forms of communication known by those skilled in the art.

Returning to operation 604, if the user elects to post bail for an inmate, such a selection is received in operation 620. In operation 622, the name of the inmate is verified through one more search criteria received from the user. In one embodiment, if the user is accessing the service from a website over the Internet, a selected correctional facility is also provided. Alternatively, if the user is accessing the service from a kiosk, the correctional facility is evident due to the location of the kiosk within a facility. Once the correct inmate is verified, a request for the bail amount is received in operation 624. In one embodiment, the amount of bail is provided to the user.

In optional operation 626, a transaction and/or processing fee(s) may be added to the bail amount. Such fees may be based on a fixed amount and/or based on a percentage of the bail amount. The additional fees are then presented to the user. If the user agrees to and accepts the fees, a funding source is received in operation 628. If the user is accessing the service through a kiosk, the funding source may come in the form of cash inserted into a coin/bill reader or in the form of a credit/debit card swiped through a card reader. Alternatively, if the user is accessing the service through a website, the funding source is received in the form of credit/debit card information and a billing address. Once, the funding source has been received and verified, the inmate's status is updated to show that bail has been posted. In operation, 630 correctional facility personnel are notified that bail has been posted. If the user is accessing the service from a kiosk, the kiosk communicates to a database of the correctional facility to update the records of the inmate. If the user is accessing the service from a website, a web server associated with the correctional facility communicates to a database of the correctional facility to update the records of the inmate. Lastly, in operation 632 a verification of the bail being posted is provided to the user. Such verification could be in the form of a printed receipt from a kiosk, through email, text message or any other forms of communication known by those skilled in the art.

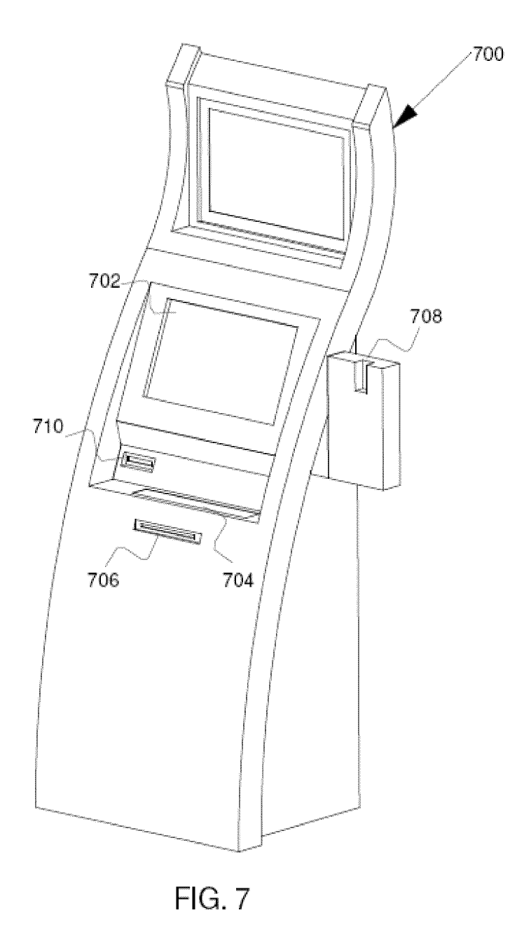

FIG. 7 illustrates a perspective view of an automated kiosk. The following illustration and description is merely an example of an automated kiosk design. One skilled in the art should realize that this design is but one of many potential designs that may be used without deviating from the scope of the invention. The kiosk 700 is a standalone device roughly 5-6 feet in height. In this embodiment, kiosk 700 comprises a display monitor 702 and a keyboard 704. In one embodiment, the display monitor 702 may be configured as a touch screen display. The kiosk 700 also comprises a printer 706. The printer 706 is configured to provide a printed verification of a transaction to a user of the kiosk 706. The kiosk further includes a coin/bill reader 708 where both coin and paper bills can be inserted into the kiosk 710 for funding of a transaction. Lastly, the kiosk includes a credit/debit card reader 710 for reading the magnetic strip on a card. Not shown, but included within the kiosk 700 are a computer for processing transactions and a network device for communicating with a computing system of a correctional facility.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. It should be understood that logical operations may be performed in any order, unless explicitly claimed otherwise or a specific order is inherently necessitated by the claim language. Furthermore, it should be appreciated that the logical steps disclosed herein may be stored on any computer readable storage medium.

The above specification, examples, and data provide a complete description of the structure and use of example embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method of booking an inmate into a correctional facility, comprising:
entering the inmate's identification information into a kiosk;
inserting money in possession of the inmate into kiosk; and
receiving a verification of the received money.

2. The method of claim 1, wherein the booking kiosk comprises:
an input device;
a display;
a printing device;
a communication interface; and
a funding source receiver.

3. The method of claim 1, wherein the kiosk is communicatively coupled to a database associated with the correctional facility.

4. The method of claim 1, further comprising:
receiving an acceptance of the inmate's booking.

5. The method of claim 1, wherein the operation of receiving verification of the received money further comprises:
receiving a printed receipt.

6. A method of receiving money on behalf of an inmate at a correctional facility, comprising:
providing a kiosk to a user, wherein the kiosk is located within the correctional facility;
receiving a funding source from the user via the kiosk; and
associating the funding source with the inmate.

7. The method of claim 6, wherein the funding source is utilized in a way selected from the group consisting of: posting bail for the inmate, adding funds to the inmate's commissary account, and paying for the inmate's work release fees.

8. The method of claim 6, wherein the operation of associating the funding source with the inmate, further comprises:
updating a database associated with the correctional facility.

9. The method of claim 7, wherein the operation of posting bail for the inmate, further comprises:
notifying correctional facility personnel that the inmate posted bail.

10. The method of claim 6, further comprising:
presenting a processing fee to the user, wherein the processing fee is related to the amount of the received funding source.

11. The method of claim 10, wherein the received funding source includes the transaction amount and the processing fee associated with the transaction.

12. A method of receiving a request to book an inmate into a correctional facility, comprising:
receiving identification information of an inmate at a kiosk;
receiving money in possession of the inmate via the kiosk;
associating the received money with the inmate's account; and
providing verification of the received money.

13. The method of claim 12, further comprising:
scanning the inmate's fingerprint; and
updating one or more databases with the fingerprint record.

14. The method of claim 12, further comprising:
scanning the inmate's face with a facial rendering device coupled to the kiosk;
rendering a three dimensional model of the inmate's face; and
updating one or more databases with the rendered model.

15. The method of claim 12, wherein the operation of associating the received money with the inmate's account further comprises:
updating a database associated with correctional facility of the received money.

16. The method of claim 12, further comprising:
providing a printed verification of the received money.

17. A correctional facility kiosk located within a correctional facility, comprising:
a CPU;
a memory;
an input device;
a display;
a funding source receiver;
a communication device for communicating with a computing system of a correctional facility; and
a printer.

18. The kiosk of claim 17, further comprising:
a fingerprint scanner for scanning a fingerprint of an inmate upon booking and upon release, wherein the fingerprints may be analyzed to verify that each fingerprint is associated with the same inmate before the inmate may be released.

19. The kiosk of claim 17, further comprising:
a facial recognition device for scanning and rendering a three dimensional model of an inmate's face upon booking and upon release, wherein the model may be analyzed to verify that each facial model is associated with the same inmate before the inmate may be released.

20. The method of claim 18, wherein the fingerprint may be communicated to one or more law enforcement agencies.

21. The method of claim 19, wherein the facial model may be communicated to one or more law enforcement agencies.

22. The kiosk of claim 17, further comprising:
a money card dispenser, wherein a money card may be dispensed to an inmate upon release, the money card containing an amount of credit equal to a credit balance associated with the inmate.

23. A correctional facility system, comprising:
a booking kiosk configured to automate steps for booking an inmate into the correctional facility, wherein the booking kiosk is further configured to communicate with one or more databases associated with the correctional facility to provide information about the inmate's booking.

24. The system of claim 23, wherein the booking kiosk is further configured to receive money in possession of the inmate and provide a verification of the received money to the one or more databases.

25. The system of claim 23, further comprising:
a lobby kiosk configured to automate steps for providing a source of money to the inmate, wherein the lobby kiosk is further configured to communicate with the one or more databases associated with the correctional facility to provide information about a source of money received and associated with the inmate.

26. The System of claim 25, wherein the lobby kiosk is further configured to allocate an amount of received money to post bail of the inmate.

27. The system of claim 23, further comprising:
a web server communicatively coupled to the one or more databases, wherein the web server is configured to provide a website to a user whereby a user may provide a source of money to the inmate, the web server is further configured to communicate a received amount of money to the one or more databases.

28. The system of claim 27, wherein the web server is further configured to communicate to the correctional facility that the inmate's bail has been posted.

29. The system of claim 23, wherein the booking kiosk is further configured to dispense a money card to the inmate upon release, wherein the money card contains an amount of credit equal to a credit balance associated with the inmate.
